(19) United States
(12) Patent Application Publication
(10) Pub. No.: US 2011/0048554 A1
(43) Pub. Date: Mar. 3, 2011

(54) SPRAYER PRESSURE RELIEF VALVE

(76) Inventors: Eric J. Finstad, Rogers, MN (US); William M. Blenkush, Becker, MN (US)

(21) Appl. No.: 12/991,610

(22) PCT Filed: May 7, 2009
(86) PCT No.: PCT/US09/43077

§ 371 Date: Nov. 8, 2010

Related U.S. Application Data
(60) Provisional application No. 61/051,919, filed on May 9, 2008.

(51) Int. Cl. F16K 1/14

(52) U.S. Cl. 137/535

(57) ABSTRACT

The pressure relief valve of the instant invention allows automatic operation when over pressurization occurs and also allows the user to operate manually when required. Passages within the valve are minimized in length and an expanding cross-section outlet geometry is used to ensure that operation of valve is not hindered by dried material after initial use. A shield is also incorporated to ensure safe discharge in case of over pressurization.

This application claims the benefit of U.S. Application Ser. No. 61/051,919, filed May 9, 2008, the contents of which are hereby incorporated by reference.

### TECHNICAL FIELD

1. Background Art

Pressure relief valves are well known for use with sprayers that operate at elevated pressures. Such a valve is required to open when exposed to a pressure in excess of a predetermined minimum. Prior art valves tend to be very prone to packing out when used with materials having a high solids content such as various types of texture material. When this happens, the solids form a blockage in the outlet or other passage of the pressure relief valve.

2. Disclosure of the Invention

The pressure relief valve of the instant invention allows automatic operation when over pressurization occurs and also allows the user to operate manually when required. Passages within the valve are minimized in length and specialized geometry is used to ensure that operation of valve is not hindered by dried material after initial use. A shield is also incorporated to ensure safe discharge in case of over pressurization. The pressure relief valve may be activated repeatedly. Also the valve allows for manual operation in case the hose is packed out and pressure cannot be relieved in the system at the spray valve.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a cross-section of the pressure relief valve of the instant invention.

FIG. 2 shows a cross-section of the pressure relief valve of the instant invention as incorporated in the outlet of a reciprocating piston pump.

### BEST MODE FOR CARRYING OUT THE INVENTION

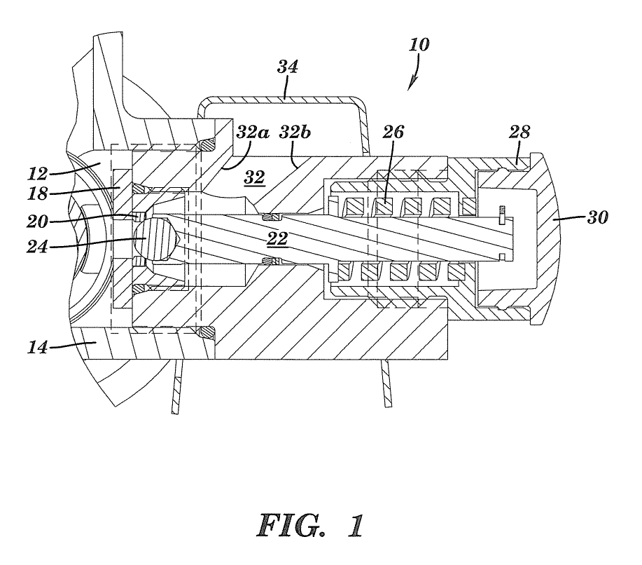

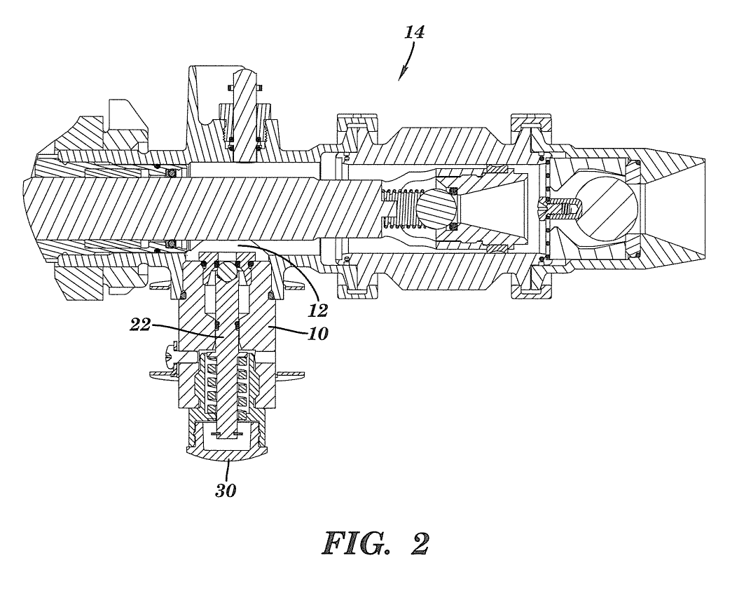

The pressure relief valve 10 of the instant invention is shown in detail in FIG. 1 and as attached to the outlet 12 of a reciprocating piston pump 14 in FIG. 2. Valve 10 is comprised of a housing 16, a seat holder 18 threadedly retained therein, a seat 20 located in seat holder 18, a valve stem 22 having a ball 24 in the end thereof. A spring 26 is located between valve stern 22 and cap 28 to bias valve 10 into the closed position wherein ball 24 seats against seat 20. Cap 28 is threadedly attached to housing 16 and the end is covered by cap 30.

In the preferred embodiment, valve 10 is threaded directly into the outlet passage 12 of pump 14 minimizing the amount of space that can contain material. Valve outlet passage 32 increases in cross-section as the distance from the ball 24-seat 20 area increases. Put another way, the proximal end 32a of passage 32 is smaller in cross-section than the distal end 32b. A shield 34 may be used to deflect high pressure material released by the valve 10 so that the energy contained therein may be dissipated.

It is contemplated that various changes and modifications may be made to the pressure relief valve without departing from the spirit and scope of the invention as defined by the following claims.

1. A pressure relief valve for an airless sprayer, said pressure relief valve comprising:
a housing;
a seat holder threadedly retained in said housing:
a seat located in said seat holder;
a valve stern having a ball in the end thereof;
a cap; and
a spring located between said valve stem and said cap to bias said valve into the closed position wherein said ball seats against said seat.

2. The pressure relief valve of claim 1 wherein said cap is threadedly attached to said housing.

3. In combination with an airless sprayer with a pump having an outlet passage, the pressure relief valve of claim 1 wherein said pressure relief valve is threaded directly into said outlet passage of said pump minimizing the amount of space that can contain material.

4. The pressure relief valve of claim 1 wherein said valve comprises an outlet passage and wherein said outlet passage increases in cross-section as the distance from said ball and said seat increases.

5. The pressure relief valve of claim 1 wherein further comprising a shield to deflect high pressure material released by said valve so that the energy contained therein may be dissipated.
